(19) United States
(12) Patent Application Publication
(10) Pub. No.: US 2014/0181945 A1
(43) Pub. Date: Jun. 26, 2014

(54) SINGLE-POINT LOGIN SYSTEM AND METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHUNG-I LEE, New Taipei (TW); DE-YI XIE, Shenzhen (CN); MI-HUA ZHAO, Shenzhen (CN)

(73) Assignees: HON HAI PRECISON INDUSTRY CO., LTD., New Taipei (TW); HONG FU JIN PRECISION INDUSTRY (ShenZhen) CO., LTD., Shenzhen (CN)

(21) Appl. No.: 14/097,280

(22) Filed: Dec. 5, 2013

(30) Foreign Application Priority Data
Dec. 21, 2012 (CN) 2012105625537

(51) Int. Cl. G06F 21/41

(52) U.S. Cl. CPC G06F 21/41
USPC 726/8

(57) ABSTRACT

When a server receives a request for accessing a first business system from a client and a first request data packet sent from another business system, the server determines that an access mode of the client is single-point login access. Then the server validates if the client has authority to access the first business system according to data in the first request data packet and data in an information list, and allows the client to access the first business system if the client has the authority, or rejects the client to access the first business system if the client does not have the authority. When receiving a request of switching the client from the first business system to a second business system, the server sends a second request data packet to the second business system.

### BACKGROUND

1. Technical Field

Embodiments of the present disclosure relate to access authorization validation systems and methods, and more particularly to a single-point login system and a single-point login method for accessing different business systems.

2. Description of Related Art

An enterprise or organization may provide a plurality of different business systems to clients, and the different business systems are often compatible and deliberately exposed to each other for business purposes. However, to ensure data security, when a client accesses each of the different business systems, the client is required to input validation information (such as user identification and a password), which may result in repetitive and time-consuming authorization processes.

### BRIEF DESCRIPTION OF THE DRAWINGS

FIG. 1 is a block diagram of one embodiment of an application environment of a single-point login system.

FIG. 2 is a block diagram of one embodiment of function modules of the single-point login system of FIG. 1.

FIG. 3 is a block diagram of one embodiment of a single-point login method for accessing different business systems.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

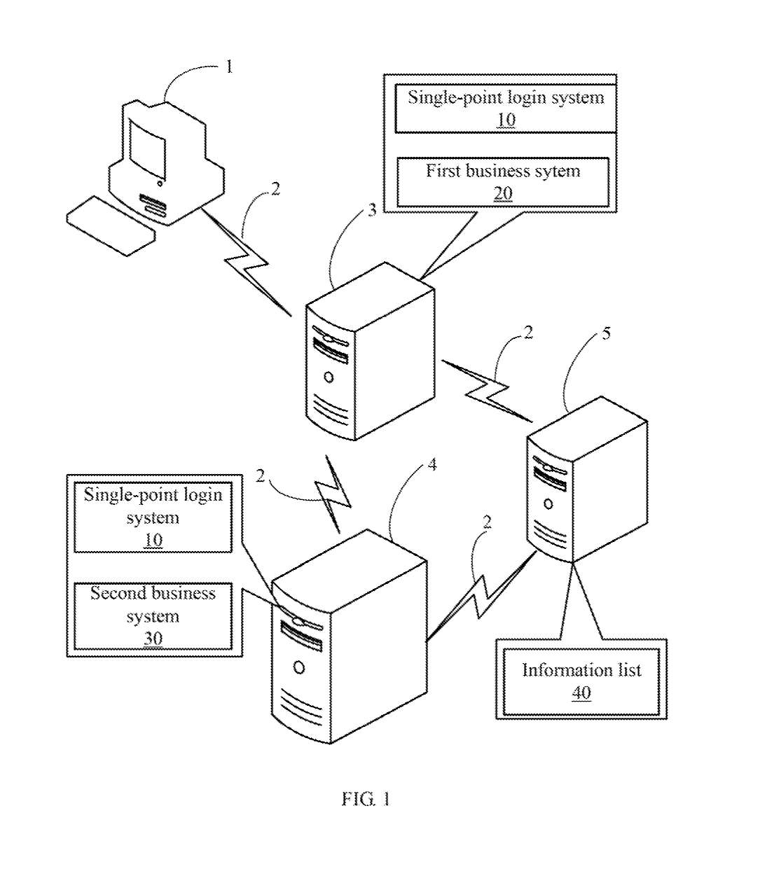

FIG. 1 is a block diagram of one embodiment of an application environment of a single-point login system 10. As shown in FIG. 1, one or more clients 1 (only one is shown) are connected to one or more business servers, such as a business server 3 and a business server 4, via a network 2. The one or more business servers are connected to a validation server 5 via the network 2. Each of the one or more business servers is installed with the single-point login system 10. For example, the business server 3 is installed with the single-point login system 10 and a first business system 20. The business server 4 is installed with the single-point login system 10 and a second business system 30. The validation server 5 includes an information list 40. The information list 40 stores data in relation to the one or more clients and the one or more business systems. For example, the data may include a user name of each client 1 and information in relation to each business system that is allowed to be accessed by the client 1, such as an identifier of the business system, an IP address of a business server in which the business system is installed, an access key for accessing the business system, and the like. The one or more business systems provide different business servers to the one or more clients 1. For example, the first business system 20 may permit each client 1 to query all services/products provided by an enterprise, and the second business system 30 may facilitate the ordering of services/products of one brand provided by the enterprise.

In this embodiment, the first business system 20, the second business system 30, and the information list 40 are stored in different servers. In another embodiment, the first business system 10, the second business system 20, and the information list 40 may be stored in the same server.

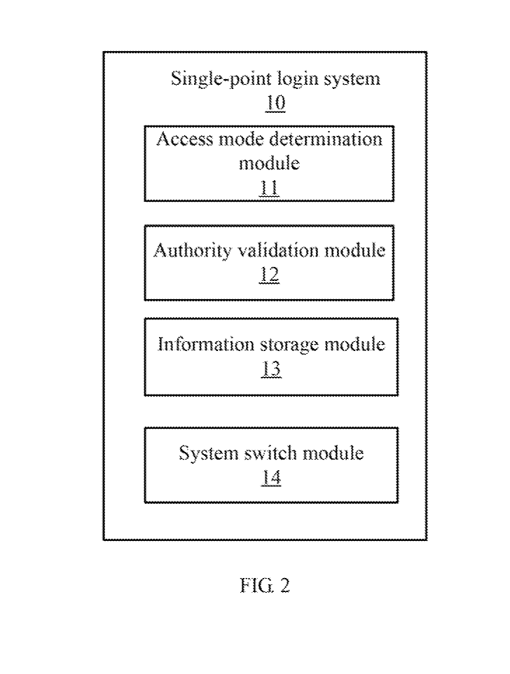

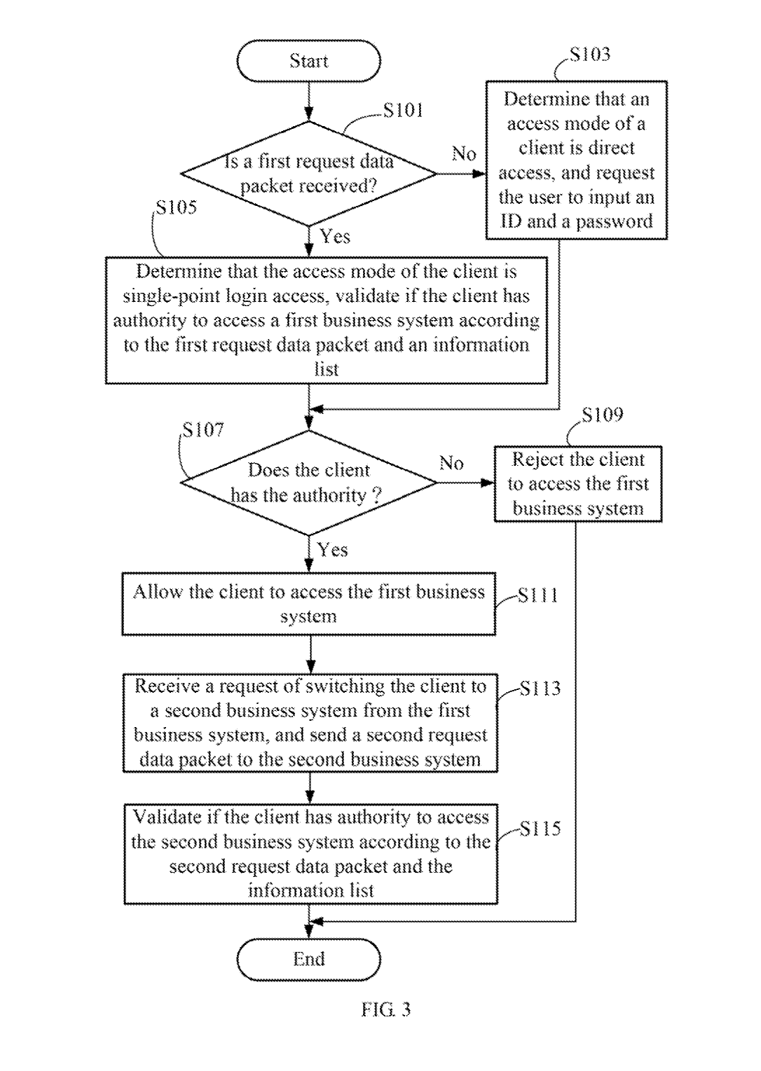

As shown in FIG. 2, the single-point login system 10 includes an access mode determination module 11, an authority validation module 12, an information storage module 13, and a system switch module 14. The modules 11-14 include computerized code in the form of one or more programs. The computerized code is stored in a storage device (not shown) of a server (e.g., the business server 3 or the business server 4) in which the single-point login system 10 is installed, and a processor of the server executes the computerized code, to provide functions of the modules which are described below, with reference to FIG. 3. The storage device may be a dedicated memory, such as an EPROM, a hard disk drive (HDD), or a flash memory.

FIG. 3 is a block diagram of one embodiment of a single-point login method. Depending on the embodiment, additional steps may be added, others removed, and the ordering of the steps may be changed.

In step S101, when receiving a request to access the first business system 20 from a client 1 (e.g., the client 1 connects to the business server 3 and opens a webpage of the first business system 20), the access mode determination module 11 determines an access mode of the client 1 is single-point login access by determining if the first business system 20 receives a first request data packet sent from another business system (such as the second business system 20). If the first business system 20 does not receive a first request data packet from another business system, step S103 is implemented, or if the first business system 20 receives a first request data packet sent from another business system (such as the second business system 30), step S105 is implemented.

In step S103, the access mode determination module 11 determines that the access mode of the client 1 is direct access, and requests a user of the client 1 to input an identification (ID) and a password, and then the procedure goes to step S107.

In step S105, the access mode determination module 11 determines that the access mode of the client 1 is single-point login access. That is, the client 1 intends to log into the first business system 20 from a previously-logged business system (such as the second business system 30) that the client 1 previously logged. The authority validation module 12 validates if the user of client 1 has authority to access the first business system 20 according to data stored in the first request data packet and data stored in the information list 40. The data stored in the first request data packet includes an IP address of a business server in which the previously-logged business system is installed, a user name that the client 1 used to log into the previously-logged business system, and an access key for accessing the first business system 20.

In step S107, the authority validation module 12 determines if the user of client 1 has the authority to access the first business system 20 by determining if the data stored in the first request data packet is in accordance with the data stored in the information list 40. For example, on condition that the access key for accessing the first business system 20 stored in the first request data packet is the same as the access key for accessing the first business system 20 stored in the information list 40, and the user name that the client 1 used to log into the previously-logged business system is also stored in the information list 40, the authority validation module 12 determines that the user of client 1 has the authority to access the first business system 20, then step S111 is implemented. Otherwise, if the data stored in the first request data packet is not in accordance with the data stored in the information list 40, step S109 is implemented, the authority validation module 12 rejects the client 1 to access the first business system 20, and the procedure ends. For example, if the access key for accessing the first business system 20 stored in the first request data packet is different from the access key for accessing the first business system 20 stored in the information list 40, or if the user name that the client 1 used to log into the previously-logged business system is not stored in the information list 40, the authority validation module 12 rejects the client 1 to access the first business system 20.

In step S111, the authority validation module 12 allows the client 1 to access the first business system 20. The information storage module 13 stores information in relation to the client 1 in a storage device (not shown) of the business server 3.

In step S113, the system switch module 14 receives a request of switching the client 1 from the first business system 20 to the second business system 30, and sends a second request data packet to the second business system 30 to validate authority of accessing the second business system 30. The second request data packet contains data similar to the data contained in the first request data packet, such as an IP address of the business server 3 in which the first business system 20 is installed, a user name that the client 1 used to log into the first business system 20, and an access key for accessing the second business system 30.

In step S115, the authority validation module 12 stored in the second business server 4 determines if the user of client 1 has the authority to access the second business system 30 by determining if the data in the second request data packet is in accordance with the data in the information list 40. A rule for determination here is similar to that of step S107 described above.

The single-point login system and method described above allows a user/client to switch between authorized business systems without repetitious validations.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A single-point login method being executed by a processor of a server, comprising:
when receiving a request of accessing a first business system sent from a client, determining an access mode of the client is single-point login access or direct access by determining whether the first business system receives a first request data packet sent from another business system;
validating if the client has authority to access the first business system according to an identification (ID) and a password of the client in response to determining that the access mode of the client is direct access, or validating if the client has the authority to access the first business system according to data stored in the first request data packet and data stored in an information list in response to determining that the access mode of the client is single-point login access;
allowing the client to access the first business system if the client has the authority, or rejecting the client to access the first business system if the client does not have the authority; and
receiving a request of switching the client from the first business system to a second business system, and sending a second request data packet to the second business system, to validate if the client has authority of accessing the second business system.

2. The method as claimed in claim 1, wherein the information list comprises a user name of the client, an identifier of each of one or more business systems allowed to be accessed by the client, an IP address of a server in which each of the one or more business systems is installed, and an access key for accessing each of the one or more business systems.

3. The method as claimed in claim 1, wherein the data stored in the first request data packet comprises an IP address of a server in which a previously-logged business system is installed, a user name that the client used to log into the previously-logged business system, and an access key for accessing the first business system.

4. The method as claimed in claim 1, wherein the first business system, the second business system, and the information list are stored in different servers.

5. The method as claimed in claim 1, wherein the first business system, the second business system, and the information list are stored in the same server.

6. A server, comprising:
a processor; and
a storage device that stores one or more programs, when executed by the processor, causing the processor to perform operations of:
when receiving a request of accessing a first business system sent from a client, determining an access mode of the client is single-point login access or direct access by determining whether the first business system receives a first request data packet sent from another business system;
validating if the client has authority to access the first business system according to an identification (ID) and a password of the client in response to determining that the access mode of the client is direct access, or validating if the client has the authority to access the first business system according to data stored in the first request data packet and data stored in an information list in response to determining that the access mode of the client is single-point login access;
allowing the client to access the first business system if the client has the authority, or rejecting the client to access the first business system if the client does not have the authority; and
receiving a request of switching the client from the first business system to a second business system, and sending a second request data packet to the second business system, to validate if the client has authority of accessing the second business system.

7. The server as claimed in claim 6, wherein the information list comprises a user name of the client, an identifier of each of one or more business systems allowed to be accessed by the client, an IP address of a server in which each of the one or more business systems is installed, and an access key for accessing each of the one or more business systems.

8. The server as claimed in claim 6, wherein the data stored in the first request data packet comprises an IP address of a server in which a previously-logged business system is installed, a user name that the client used to log into the previously-logged business system, and an access key for accessing the first business system.

9. The server as claimed in claim 6, wherein the first business system, the second business system, and the information list are stored in different servers.

10. The server as claimed in claim 6, wherein the first business system, the second business system, and the information list are stored in the same server.

11. A non-transitory computer-readable medium having stored thereon instructions that, when executed by a processor of a server, causing the processor to perform a method comprising steps:
when receiving a request of accessing a first business system sent from a client, determining an access mode of the client is single-point login access or direct access by determining whether the first business system receives a first request data packet sent from another business system;
validating if the client has authority to access the first business system according to an identification (ID) and a password of the client in response to determining that the access mode of the client is direct access, or validating if the client has the authority to access the first business system according to data stored in the first request data packet and data stored in an information list in response to determining that the access mode of the client is single-point login access;
allowing the client to access the first business system if the client has the authority, or rejecting the client to access the first business system if the client does not have the authority; and
receiving a request of switching the client from the first business system to a second business system, and sending a second request data packet to the second business system, to validate if the client has the authority of accessing the second business system.

12. The medium as claimed in claim 11, wherein the information list comprises a user name of the client, an identifier of each of one or more business systems allowed to be accessed by the client, an IP address of a server in which each of the one or more business systems is installed, and an access key for accessing each of the one or more business systems.

13. The medium as claimed in claim 11, wherein the data stored in the first request data packet comprises an IP address of a server in which a previously-logged business system is installed, a user name that the client used to log into the previously-logged business system, and an access key for accessing the first business system.

14. The medium as claimed in claim 11, wherein the first business system, the second business system, and the information list are stored in different servers.

15. The medium as claimed in claim 11, wherein the first business system, the second business system, and the information list are stored in the same server.
